(19) United States
(12) Patent Application Publication
(10) Pub. No.: US 2025/0120334 A1
(43) Pub. Date: Apr. 17, 2025

(54) Removable Spreader Hopper

(71) Applicant: Stinger Equipment Inc., Buckner, KY (US)

(72) Inventor: David Michael Cook, Jekyll Island, GA (US)

(21) Appl. No.: 18/913,712

(22) Filed: Oct. 11, 2024

Related U.S. Application Data
(60) Provisional application No. 63/589,918, filed on Oct. 12, 2023.

(51) Int. Cl. A01C 15/00; A01M 7/00

(52) U.S. Cl. CPC A01C 15/006; A01M 7/0085

(57) ABSTRACT

A turf applicator including a main body, a primary spray tank, an auxiliary spray tank, and a removable fertilizer hopper, where only one of the auxiliary spray tank or the removable fertilizer hopper is used at a time, a controller; and a removable frame. The removeable frame includes: a plurality of connection points to secure the removable fertilizer hopper or the auxiliary spray tank to the main body, a plurality of mounting flanges to support the removable fertilizer hopper or the auxiliary spray tank, and at least one vertical slot where at least one wing nut and at least one carriage bolt secure the removable frame with the removable fertilizer hopper or the auxiliary spray tank to the main frame. When the auxiliary spray tank is used the controller enables fluid transfer from the auxiliary spray tank to the primary spray tank to balance weight distribution.

### BACKGROUND OF THE INVENTION

Riding turf applicators are widely used in the turf industry to treat turf with both liquid and granular products to control weeds, control disease, add soil amendments, and/or apply fertilizer. Some applicators are set up to spread only granular products, and other applicators are set up to spray only liquid products. However, most applicators are setup to apply both liquid and granular products.

Sometimes manufactures produce a machine dedicated to the use of liquid applications using one large tank or multiple smaller tanks. Using one large tank may result in water rapidly shifting from side to side when the turf applicator is traversing hills making the applicator unstable to operate. To improve stability, manufactures may offer multiple tanks in order to reduce the effect of the liquid contents of the tank(s) rapidly shifting from side to side; however, the use of multiple tanks may increase user workload and complexity. In the example where the turf applicator has multiple tanks, the operator of the turf applicator is required to manually transfer the liquid from tank to tank through a network of valves and/or pumps to keep the unit balanced (e.g., so it remains safe to operate).

Turf professionals may apply multiple rounds of treatments a year to keep turf looking as good as possible. Some of these treatments are all liquid, some treatments are all granular material, and some treatments are a combination of liquid and granular materials. Traditionally, turf professionals set up a machine for four to six weeks apply the same product to all turf; then the next round of application with a different product or set of products. To increase product flexibility, most turf professionals have machines designed to apply both liquid and granular products. To increase efficiency when doing liquid only applications, turf professionals also have dedicated machines designed to only spray liquids. In recent years, turf professionals are starting to applying more liquid treatments, in order to apply multiple products at once in a solution, and because liquid treatments often cost less than the application of granular products.

These products, specifically granular products, are often highly corrosive. For this reason, most turf applicators are made from stainless steel. Even though the machines are predominately made from stainless steel, users may still be required to thoroughly clean these corrosive materials from the machines on a regular basis.

Accordingly, there is a need in the art for a machine that can apply both liquid and granular products while also quickly and easily transforming into an all-liquid machine for more efficient application of liquid-only products. Additionally, when utilized as an all-liquid machine (with multiple tanks), the machine should automatically transfer liquid from tank to tank to reduce operator efforts to keep the machine balanced.

### SUMMARY OF THE INVENTION

There is a need for a turf applicator capable with the flexibility to allow the operator to switch from a traditional applicator that is capable of both spreading and spraying products for turf applications to a machine that applies liquid only applications with greater spray tank capacity. This machine should also automatically transfer fluid from front to back or side to side depending on the configuration to automatically balance the weight of each tank to keep a good weight distribution for safe operation on hills.

There is also a need for a turf applicator where you can easily remove the fertilizer hopper to clean and empty the fertilizer hopper at the end of each day. This will also allow for easier cleaning and routing maintenance on the additional as well.

In a first aspect, a turf applicator includes: a main body; a primary spray tank to contain a liquid material; a removable frame, where the removable frame includes a plurality of connection points to removably secure the removable frame to the main body and a plurality of mounting flanges to support a removable fertilizer hopper or an auxiliary spray tank.

In some implementations, the connection points slide down and back to secure the removable fertilizer hopper. In some implementations, the removable frame further includes at least one vertical slot where at least one wing nut and at least one carriage bolt secure the removable frame with the removable fertilizer hopper or the auxiliary spray tank to the main frame.

In some implementations, the removable fertilizer hopper further includes an electrical connection that controls distribution of material from the removable fertilizer hopper.

In some implementations, the auxiliary spray tank further includes a pump to transfer fluid. In some such implementations, the auxiliary spray tank operates independent of the primary spray tank via a hose connected to the pump. In some implementations, the auxiliary spray tank has a first solution and the primary spray tank has a second solution.

In some implementations, the turf applicator additionally includes a controller that enables fluid transfer from the auxiliary spray tank to the primary spray tank to balance weight distribution. In some such implementations, the weight distribution is determined through one or more fluid level sensors to measure how much fluid is in each of the auxiliary spray tank and the primary spray tank. In some implementations, the weight distribution is determined by one or more pressure sensors to measure how much fluid is in each of the auxiliary spray tank and the primary spray tank.

In another aspect a turf applicator includes: a main body; a primary spray tank to contain a liquid material; a removable frame, wherein the removable frame includes a plurality of connection points that slide down and back to removably secure a removable fertilizer hopper or an auxiliary spray tank to the main body, a plurality of mounting flanges to support the removable fertilizer hopper or the auxiliary spray tank, and at least one vertical slot where at least one wing nut and at least one carriage bolt secure the removable frame with the removable fertilizer hopper or the auxiliary spray tank to the main frame.

In some implementations, the removable fertilizer hopper further includes an electrical connection that controls distribution of material from the removable fertilizer hopper.

In some implementations, the auxiliary spray tank further includes a pump to transfer fluid. In some such implementations, the auxiliary spray tank operates independent of the primary spray tank via a hose connected to the pump. In some implementations, the auxiliary spray tank has a first solution and the primary spray tank has a second solution.

In some implementations, the turf applicator additionally includes a controller that enables fluid transfer from the auxiliary spray tank to the primary spray tank to balance weight distribution. In some implementations the weight distribution is determined through one or more fluid level sensors to measure how much fluid is in each of the auxiliary spray tank and the primary spray tank. In other implementations, the weight distribution is determined by one or more pressure sensors to measure how much fluid is in each of the auxiliary spray tank and the primary spray tank.

In yet another aspect, a turf applicator including: a main body; a primary spray tank to contain a liquid material; an auxiliary spray tank to contain a liquid material and a removable fertilizer hopper to contain a granular material, wherein only one of the auxiliary spray tank or the removable fertilizer hopper is used at a time; a controller; a removable frame including a plurality of connection points that slide down and back to removably secure the removable fertilizer hopper or the auxiliary spray tank to the main body, a plurality of mounting flanges to support the removable fertilizer hopper or the auxiliary spray tank, at least one vertical slot wherein at least one wing nut and at least one carriage bolt secure the removable frame with the removable fertilizer hopper or the auxiliary spray tank to the main frame; and where when the auxiliary spray tank is used the controller enables fluid transfer from the auxiliary spray tank to the primary spray tank to balance weight distribution.

### BRIEF DESCRIPTION OF THE DRAWINGS

In order that the embodiments may be better understood, embodiments of an applicator control user interface will now be described by way of examples. These embodiments are not to limit the scope of the claims as other embodiments of a removable spreader hopper will become apparent to one having ordinary skill in the art upon reading the instant description. Non-limiting examples of the present embodiments are shown in figures.

FIG. 1. is an isometric view of a turf applicator with a removable spreader assembly consistent with some embodiments described herein.

FIG. 2. is an isometric view of a turf applicator of FIG. 1 with the removable spread assembly shown as attached.

FIG. 3. is an isometric view of a removable spreader in the locked position consistent with some embodiments described herein.

FIG. 4. is an isometric view of the removable spreader of FIG. 3 in the unlocked position.

FIG. 5. is an isometric view of the electrical connection of the removable spreader of FIG. 3.

FIG. 6. is an exploded view of a universal frame mount for the removable spreader assembly consistent with some embodiments described herein.

FIG. 7. is an isometric view of the universal frame mount consistent with some embodiments described herein.

FIG. 8. is an isometric view of an auxiliary spray tank attached to the turf applicator consistent with some embodiments described herein.

FIG. 9. is an isometric view of the auxiliary spray tank of FIG. 8 removed from the turf applicator.

FIG. 10. is an isometric view of a transfer pump on the auxiliary spray tank consistent with some embodiments described herein.

FIG. 11. is and isometric view of the turf applicator consistent with some embodiments described herein without the front attachment.

### DETAILED DESCRIPTION OF THE INVENTION

It is to be understood that a removable spreader hopper is not limited in its application to the details of construction and the arrangement of components set forth in the following description or illustrated in the drawings. The described embodiments are capable of other embodiments and of being practiced or of being carried out in various ways. Also, it is to be understood that the phraseology and terminology used herein is for the purpose of description and should not be regarded as limiting. The use of “including,” “comprising,” or “having” and variations thereof herein is meant to encompass the items listed thereafter and equivalents thereof as well as additional items. Unless limited otherwise, the terms “connected,” “coupled,” and “mounted,” and variations thereof herein are used broadly and encompass direct and indirect connections, couplings, and mountings. In addition, the terms “connected” and “coupled” and variations thereof are not restricted to physical or mechanical connections or couplings.

Reference throughout this specification to “one embodiment”, “some embodiments” or “an embodiment” means that a particular feature, structure or characteristic described in connection with the embodiment is included in at least one embodiment of the present invention. Thus, appearances of the phrases “in one embodiment”, “in some embodiments” or “in an embodiment” in various places throughout this specification are not necessarily all referring to the same embodiment but may. Furthermore, the particular features, structures or characteristics may be combined in any suitable manner, as would be apparent to one of ordinary skill in the art from this disclosure, in one or more embodiments.

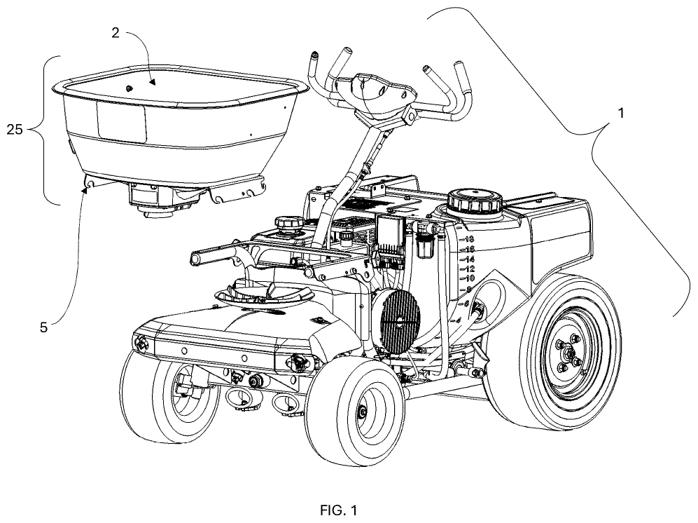

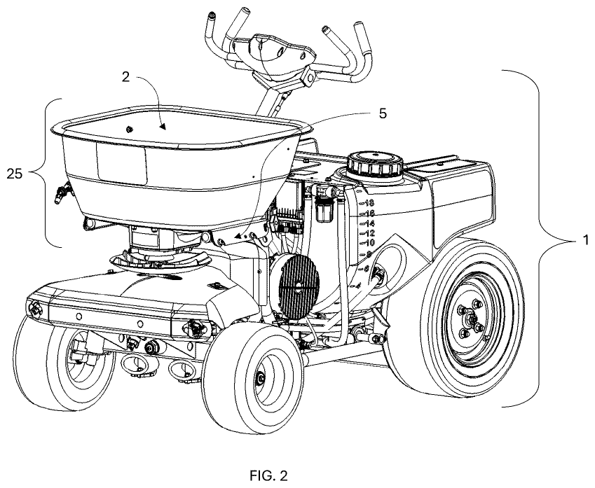

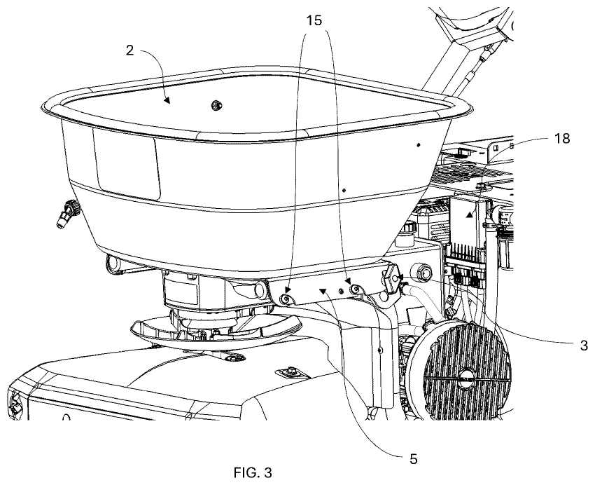

FIG. 1 shows a turf applicator 1 with a removable fertilizer hopper 2 consistent with some embodiments described herein. In the embodiment of FIG. 1, the fertilizer hopper 2 is depicted as attached to a removeable frame 5. The removable frame 5 allows the hopper 2 and frame 5 combination can be removed for easy access during routine cleaning, maintenance, and/or to attach an additional spray tank. The hopper 2 and the removable frame 5 may be collectively referred to herein as the removable fertilizer hopper assembly 25. While illustrated as substantially cuboid in shape, this is not intended to be limiting; the size of the fertilizer hopper 2 may vary. FIG. 2 illustrates the removable fertilizer hopper 2 attached to both the removable frame 5 and a main frame of the turf applicator 1. FIG. 3 shows an exemplary attachment mechanism for connecting the removable fertilizer hopper 2 attached to the turf applicator 1. The removable fertilizer hopper assembly 25 (e.g., collectively the hopper 2 and the removable frame 5) may be mounted to a removable frame 5 that is held in place at multiple connection points 15. These connection points 15 may slide down and back to secure the hopper 2, which may then hold the hopper 2 in place with a “wing nut” 3 and carriage bolt 20 on each side of the removable assembly 25. It is to be understood that the embodiment illustrated in FIG. 3 is merely exemplary, as a person of skill in the art may recognize any number of attachment mechanisms for the attachment of the removable fertilizer hopper 2 to the turf applicator 1. For example, rather than the use of a bolt and “wing nut”, the connection point may be secured through use of a screw or any removable connecting device

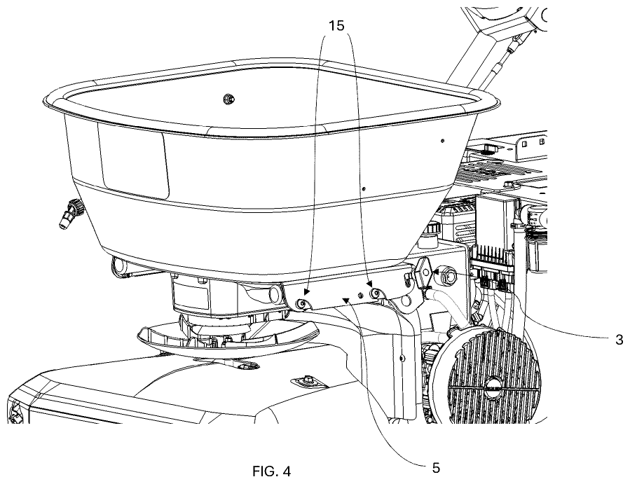

FIG. 3 additionally illustrates the “wing nut” 3 and bolt in the locked or secured position. When a user wants to remove the fertilizer hopper assembly 25, the user may loosen the “wing nut” 3 and slide the bolt upward and to the back as shown in FIG. 4.

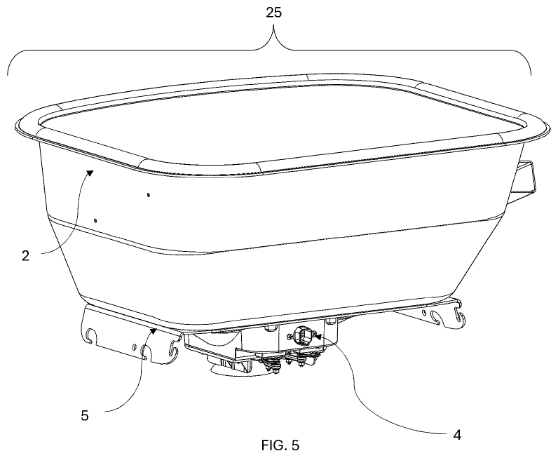

FIG. 5 shows the electrical connection 4 that operates the removable fertilizer hopper and/or controls the distribution of material when using the fertilizer hopper assembly 25 on the turf applicator 1. In some implementations, the electrical connection 4 may be coupled with (either wired or wirelessly) with the controller 18. In order to remove the fertilizer hopper assembly 25 from the turf applicator 1, a user may disconnect an electrical connection cable (not illustrated) from the electrical connector 4; the user may then pull the fertilizer hopper assembly 25 forward and upward to remove it from the turf assembly 1. Although illustrated as an electrical connection, this is not intended to be limiting; in some implementations this could also be achieved through a mechanical linkage like a control rod, push pull cable, or the like.

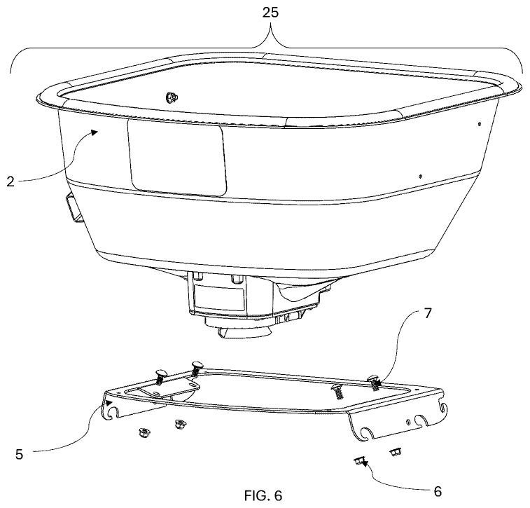

FIG. 6 shows an exploded view of the fertilizer hopper assembly 25. The removable fertilizer hopper 2 may be mounted to the removable frame 5, this frame 5 is designed to be removable from the turf applicator 1. In some implementations, the removable frame 5 is constructed of stainless-steel. In the illustrated example, the fertilizer hopper 2 is attached to the removable frame 5 using four nuts 6 and bolts 7.

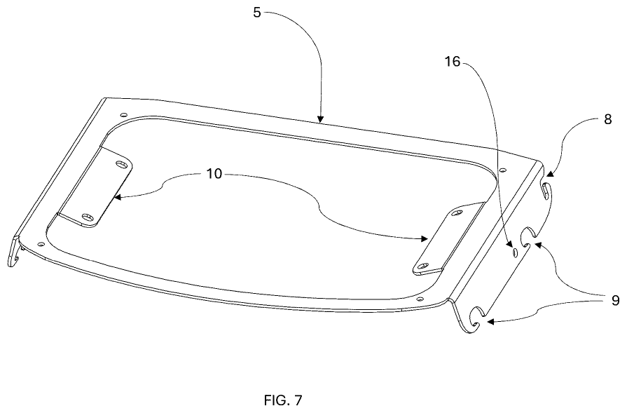

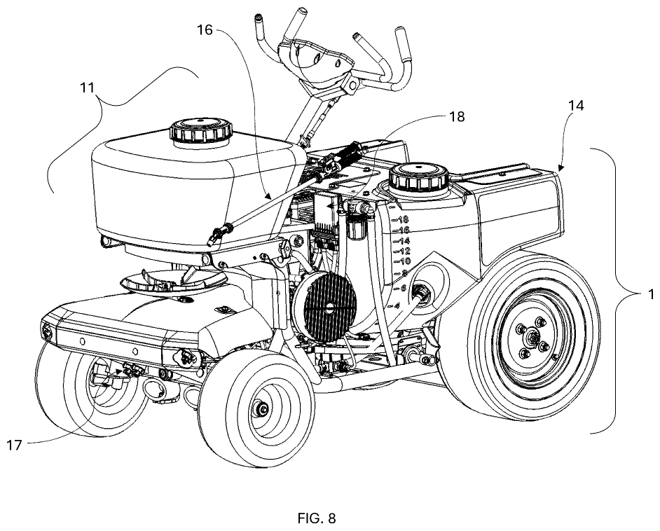

FIG. 7 shows the stainless-steel removable frame 5 of FIG. 6. The stainless-steel removable frame 5 includes mounting flanges 10 that are designed to support a removable fertilizer hopper 2 or an auxiliary spray tank 11 (see FIG. 8). The removable frame 5 also includes four slots 9, two on each side, designed to secure the fertilizer hopper assembly 25 to the turf applicator 1. The curvature of these slots 9 are designed such that the frame 5 locks into place when pushed back into position and also enables the frame 5 to be easily removed when it slides forward and then upward. To keep the assembly secure to the turf applicator 1, there may also be vertical slots 8 in the rear, one on each side, of the frame 5; these vertical slots 8 are where two carriage bolts (see reference number 20 in FIG. 2) with “wing nuts” (see reference number 3 in FIG. 2) secure the assembly in place. In some implementations, such as illustrated in FIG. 7, there is also an additional locking feature or hole 16 that passes through the removable frame 5 and corresponding a hole in the turf applicator 1 frame where a security bolt or lock (not illustrated) could be placed to make removal of the fertilizer hopper 2 or auxiliary spray tank 11 theft resistant.

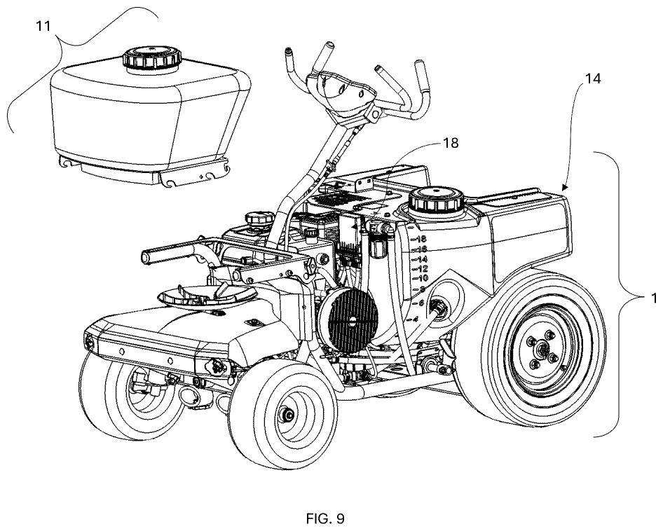

As discussed previously, in some instances it may be desirable for a user to exchange the removable fertilizer hopper 2 for an auxiliary spray tank for dispensing liquid material. FIG. 8 shows an auxiliary spray tank 11 installed on the turf applicator 1 to dispense a liquid material. In some implementations, the auxiliary spray tank 11 could be setup to transfer fluid to the primary spray tank 14 (located on the rear of the applicator 1); this would allow, for example, the same liquid product to be used in both the auxiliary spray tank 11 and the primary spray tank 14 for additional liquid capacity. In other implementations, the auxiliary spray tank 11 could be setup to carry a second product to be sprayed separately through a front mounted spray nozzle 17 or a hand spray wand 16 mounted to the side of the tank. FIG. 9 shows how the auxiliary spray tank 11 is easily removed in the same manner as the removable fertilizer hopper 2. In this example both accessories utilize the same frame 5 to attach to the turf applicator 1.

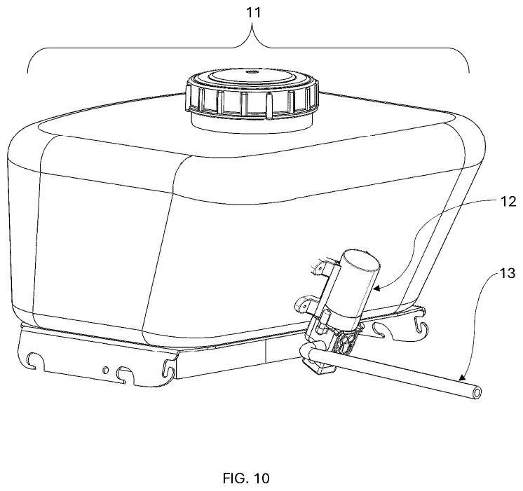

FIG. 10 shows the auxiliary spray tank 11 with a liquid pump 12. In some instances, the liquid pump 12 may be designed to transfer fluid from the auxiliary tank 11 to the primary tank 14 located on the rear of the turf applicator 1 through a hose 13. In other instances, the liquid pump 12 may be plumbed to spray a second product, separate from the applicator's primary spray tank 14, for example by utilizing the hose 13 from the pump 12. In some implementations, the hose 13 may connect to a hand spray wand 16 or to a spray tip 17 mounted on the turf applicator 1. For example, where the auxiliary tank 11 has a first solution for spraying and the primary spray tank 14 has a second solution for spraying, an operator may be able to spray the second solution from the primary spray tank 14 and the first solution from the front spray tank 11, which may increase productivity.

In the scenario where a user installs the auxiliary spray tank 11 to increase total spray capacity, the pump 12 is designed to work together with the primary spray tank 14. The applicator has a controller 18 (see FIGS. 8-9) that enables fluid to transfer from the auxiliary tank 11 to the primary tank 14 automatically to keep the weight distribution within parameters set in the controller 18. As the turf applicator 1 sprays the liquid solutions from the primary tank 14, the controller 18 calculates how much fluid should transfer from the front to the rear tank to keep the weight distribution even.

A user may select on a user interface (either on the machine or through a wireless device) that the auxiliary spray tank 11 and the primary spray tank 14 are full. As the user dispenses the liquid from the auxiliary spray tank 11 and/or the primary spray tank 14, the controller is able to determine how much liquid has been dispensed. In some implementations, this determination may be made through the use of one or more fluid level sensors to measure how much fluid there is in each of the auxiliary tank 11 and primary tank 14. In other implementations, this determination may be made through the use one or more pressure sensors to measure how much fluid is in each of the auxiliary tank 11 and primary tank 14.

For example, if two gallons of liquid are dispensed from the primary tank 14 on the rear of the applicator 1, during that period of spraying, the controller 18 would signal to the transfer pump 12 to transfer approximately 1 gal of liquid back from the auxiliary spray tank 11 to the primary spray tank 14. This results in each of the auxiliary tank 11 and primary tank 14 having been reduced in volume by 1 gallon while keeping the weight distribution of the turf applicator 1 in balance. The automatic transfer of fluid may increase the turf applicator's 1 stability when driving on hills.

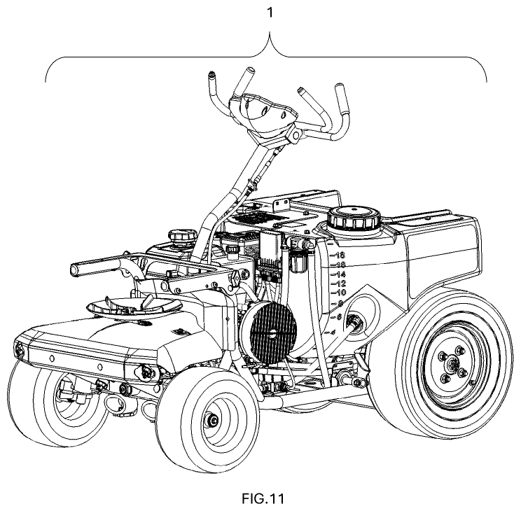

FIG. 11 illustrates the turf applicator 1 without the removable fertilizer hopper 2 or auxiliary spray tank 11 installed. The ability to remove these accessories in less than a minute without tools makes cleaning of the turf applicator 1 or performing engine maintenance much easier.

While several embodiments have been described and illustrated herein, those of ordinary skill in the art will readily envision a variety of other means and/or structures for performing the function and/or obtaining the results and/or one or more of the advantages described herein, and each of such variations and/or modifications is deemed to be within the scope of the embodiments described herein. More generally, those skilled in the art will readily appreciate that all parameters, dimensions, materials, and configurations described herein are meant to be exemplary and that the actual parameters, dimensions, materials, and/or configurations will depend upon the specific application or applications for which the teachings is/are used. Those skilled in the art will recognize, or be able to ascertain using no more than routine experimentation, many equivalents to the specific embodiments described herein. It is, therefore, to be understood that the foregoing embodiments are presented by way of example only and that, within the scope of the appended claims and equivalents thereto, embodiments may be practiced otherwise than as specifically described and claimed. Embodiments of the present disclosure are directed to each individual feature, system, article, material, and/or method described herein. In addition, any combination of two or more such features, systems, articles, materials, and/or methods, if such features, systems, articles, materials, and/or methods are not mutually inconsistent, is included within the scope of the present disclosure.

We claim:

1. A turf applicator comprising:
a main body;
a primary spray tank to contain a liquid material;
a removable frame, wherein the removable frame includes:
a plurality of connection points to removably secure the removable frame to the main body; and
a plurality of mounting flanges to support a removable fertilizer hopper or an auxiliary spray tank.

2. The turf applicator of claim 1, wherein the connection points slide down and back to secure the removable fertilizer hopper.

3. The turf applicator of claim 1, wherein the removable frame further includes at least one vertical slot wherein at least one wing nut and at least one carriage bolt secure the removable frame with the removable fertilizer hopper or the auxiliary spray tank to the main frame.

4. The turf applicator of claim 1, wherein the removable fertilizer hopper further includes an electrical connection that controls distribution of material from the removable fertilizer hopper.

5. The turf applicator of claim 1, wherein the auxiliary spray tank further includes a pump to transfer fluid.

6. The turf applicator of claim 5, wherein the auxiliary spray tank operates independent of the primary spray tank via a hose connected to the pump.

7. The turf applicator of claim 6, wherein the auxiliary spray tank has a first solution and the primary spray tank has a second solution.

8. The turf applicator of claim 5 further comprising a controller that enables fluid transfer from the auxiliary spray tank to the primary spray tank to balance weight distribution.

9. The turf applicator of claim 8, wherein the weight distribution is determined through one or more fluid level sensors to measure how much fluid is in each of the auxiliary spray tank and the primary spray tank.

10. The turf applicator of claim 8, wherein the weight distribution is determined through one or more pressure sensors to measure how much fluid is in each of the auxiliary spray tank and the primary spray tank.

11. A turf applicator comprising:
a main body;
a primary spray tank to contain a liquid material;
a removable frame, wherein the removable frame includes:
a plurality of connection points that slide down and back to removably secure a removable fertilizer hopper or an auxiliary spray tank to the main body;
a plurality of mounting flanges to support the removable fertilizer hopper or the auxiliary spray tank; and
at least one vertical slot wherein at least one wing nut and at least one carriage bolt secure the removable frame with the removable fertilizer hopper or the auxiliary spray tank to the main frame.

12. The turf applicator of claim 11, wherein the removable fertilizer hopper further includes an electrical connection that controls distribution of material from the removable fertilizer hopper.

13. The turf applicator of claim 1, wherein the auxiliary spray tank further includes a pump to transfer fluid.

14. The turf applicator of claim 13, wherein the auxiliary spray tank operates independent of the primary spray tank via a hose connected to the pump.

15. The turf applicator of claim 14, wherein the auxiliary spray tank has a first solution and the primary spray tank has a second solution.

16. The turf applicator of claim 13 further comprising a controller that enables fluid transfer from the auxiliary spray tank to the primary spray tank to balance weight distribution.

17. The turf applicator of claim 16, wherein the weight distribution is determined through one or more fluid level sensors to measure how much fluid is in each of the auxiliary spray tank and the primary spray tank.

18. The turf applicator of claim 16, wherein the weight distribution is determined through one or more pressure sensors to measure how much fluid is in each of the auxiliary spray tank and the primary spray tank.

19. A turf applicator comprising:
a main body;
a primary spray tank to contain a liquid material;
an auxiliary spray tank and a removable fertilizer hopper to contain a granular material, wherein only one of the auxiliary spray tank or the removable fertilizer hopper is used at a time;
a controller;
a removable frame including:
a plurality of connection points that slide down and back to removably secure the removable fertilizer hopper or the auxiliary spray tank to the main body;
a plurality of mounting flanges to support the removable fertilizer hopper or the auxiliary spray tank;
at least one vertical slot wherein at least one wing nut and at least one carriage bolt secure the removable frame with the removable fertilizer hopper or the auxiliary spray tank to the main frame; and
wherein when the auxiliary spray tank is used the controller enables fluid transfer from the auxiliary spray tank to the primary spray tank to balance weight distribution.
